(19) United States
(12) Patent Application Publication
(10) Pub. No.: US 2023/0008260 A1
(43) Pub. Date: Jan. 12, 2023

(54) NETWORK ENABLED 3D PRINTING AND AUTOMATED PROCESSING TECHNIQUES FOR ORAL DEVICES

(71) Applicant: Reset Technology Corporation, Wilmington, DE (US)

(72) Inventors: Justin Spencer Marks, Glen Head, NY (US); Clayton Adams Teufel, Chicago, IL (US)

(21) Appl. No.: 17/860,868

(22) Filed: Jul. 8, 2022

Related U.S. Application Data
(60) Provisional application No. 63/220,305, filed on Jul. 9, 2021.

(51) Int. Cl. B29C 64/393; B29C 64/379; B33Y 40/20; B33Y 50/02; B29C 64/245; B29C 64/40; B33Y 30/00; B33Y 10/00

(52) U.S. Cl. CPC B29C 64/393; B29C 64/379; B33Y 40/20; B33Y 50/02; B29C 64/245; B29C 64/40; B33Y 30/00; B33Y 10/00; B29L 2031/7536

(57) ABSTRACT

Network enabled 3D printing and automated processing techniques for oral devices are disclosed herein. An example technique includes receiving, via a network, a data file representative of a mouth of a user, and printing, by a 3D printer, a 3D oral device based on the data file. The example technique may further include automatically ejecting, from the 3D printer, the 3D oral device, and scanning the 3D oral device to generate a 3D scan file of the 3D oral device. The example technique may further include comparing the 3D scan file with the data file to determine at least one feature represented in the 3D scan file that exceeds a deviation threshold relative to a corresponding respective feature represented in the data file; and finishing, by a finishing module, the 3D oral device by smoothing the at least one feature on the 3D oral device.

### CROSS-REFERENCE TO RELATED APPLICATIONS

This application claims the benefit of U.S. Provisional Application No. 63/220,305, filed Jul. 9, 2021, and entitled “NETWORK ENABLED 3D PRINTING AND AUTOMATED PROCESSING TECHNIQUES FOR ORAL DEVICES”, which is incorporated herein by reference in its entirety.

### BACKGROUND

Remote dentistry (or “tele-dentistry”) is in growing demand as technology is allowing cost-effective, remote access to healthcare providers. Many patients do not have the financial wherewithal to receive dental care, want to avoid going (or fear going) to a dentist, and/or many generally do not have convenient access to a dental professional. Moreover, COVID-19 has exasperated these issues by causing widespread trepidation in receiving in-office dental care. Thus, many patients suffer from untreated and/or undiagnosed dental issues that can lead to a wide variety of deleterious health effects. Tele-dentistry can mitigate all of these issues.

For example, it is estimated that over 178 million Americans are missing one or more teeth and require dentures (including partial dentures) or dental implants to replace missing teeth. Yet, only one million or so Americans receive dentures or implants each year. Many of those with missing teeth lack access to dental services due primarily to prohibitively high costs, lack of dental offices within commuting distance, and/or lack of access to oral scanners to capture dental data. Tele-dentistry suffers from several additional drawbacks, such as a lack of patient access to remotely submit requests for oral device fabrication. However, should a patient successfully submit a request for oral device fabrication (typically through an in-office visit to a dentist), conventional techniques further suffer from non-optimized processing of the oral devices, resulting in oral devices that do not fit in patient's mouths and/or are otherwise erroneously manufactured. Conventional techniques additionally fail to provide patients any means to track/observe the progress of the fabrication of their oral device.

Thus, a need exists for network enabled 3D printing and automated processing techniques for oral devices that allow a patient to easily and remotely submit a request for an oral device that is efficiently and accurately fabricated to the patient's specifications.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Generally, as previously mentioned, technology is allowing direct-to-consumer delivery of dental-related products and services to further reduce/eliminate in-office contact and cost. Specifically, the network enabled 3D printing and automated processing techniques described herein allow consumers to remotely and independently submit oral device printing requests, which may be used to automatically print and finish oral devices for the consumer. The techniques disclosed herein provide solutions to the problems described above and others.

In one aspect, the present invention is a network enabled, three-dimensional (3D) printing and automated processing system for oral devices. The system may comprise: a 3D printer coupled with one or more processors, a scanner communicatively coupled with the 3D printer and the one or more processors, and a finishing module communicatively coupled with the one or more processors and the scanner. The 3D printer may be configured to: receive, via a network, a data file representative of a mouth of a user, print a 3D oral device based on the data file, and automatically eject the 3D oral device. The scanner may be configured to: receive the 3D oral device from the 3D printer, scan the 3D oral device to generate a 3D scan file of the 3D oral device, and compare the 3D scan file with the data file to determine at least one feature represented in the 3D scan file that exceeds a deviation threshold relative to a corresponding respective feature represented in the data file. The finishing module may be configured to: receive the 3D oral device from the scanner, and finish the 3D oral device by smoothing the at least one feature on the 3D oral device.

In a variation of this aspect, the 3D scan file may be a first 3D scan file, and the scanner may be further configured to: receive the 3D oral device from the finishing module, scan the 3D oral device to generate a second 3D scan file of the 3D oral device, and compare the second 3D scan file with the data file to determine whether or not at least one feature represented in the second 3D scan file exceeds the deviation threshold relative to a corresponding respective feature represented in the data file.

In another variation of this aspect, the finishing module may comprise at least one of a sandblaster and a vapor smoother.

In yet another variation of this aspect, the deviation threshold may be approximately 50 microns.

In still another variation of this aspect, the one or more processors may be configured to: identify a respective feature represented in the 3D scan file that deviates from a corresponding respective feature in the data file by at least 100 microns, and designate the 3D oral device for manual finishing.

In yet another variation of this aspect, the one or more processors may be configured to: convert the data file into a set of code that is executable by the 3D printer to print the 3D oral device.

In still another variation of this aspect, the 3D printer may be further configured to print the 3D oral device onto (i) a flexible build platform or (ii) a conveyor belt.

In yet another variation of this aspect, the flexible build platform may include a unique identifying label encoded with oral device data corresponding to the 3D oral device. Further in this variation, the system may further comprise a server communicatively coupled with the 3D printer, the one or more processors, the scanner, and the finishing module, wherein the server is configured to: store the data file, the 3D scan file, and the oral device data.

In still another variation of this aspect, the 3D oral device may comprise (i) a base portion, (ii) a teeth portion, and (iii) a support portion. Further in this variation, the 3D printer may be further configured to: print the 3D oral device by utilizing a first material for the base portion, a second material for the teeth portion, and a third material for the support portion. Still further in this variation, the third material for the support portion may be dissolvable, and the system may further comprise an autonomous robotic arm communicatively coupled with the one or more processors that may be configured to: place the 3D oral device into a bath configured to dissolve the support portion, automatically remove the 3D oral device from the bath when the support portion is dissolved, and place the 3D oral device into the finishing module.

In yet another variation of this aspect, the system may further comprise an autonomous robotic arm communicatively coupled with the one or more processors that is configured to: responsive to the 3D printer printing the 3D oral device, automatically grab the 3D oral device within the 3D printer to remove the 3D oral device from the 3D printer.

In another aspect, the present invention is a method for network enabled, three-dimensional (3D) printing and automated processing of oral devices. The method may comprise: receiving, via a network, a data file representative of a mouth of a user; printing, by a 3D printer, a 3D oral device based on the data file; automatically ejecting, from the 3D printer, the 3D oral device; scanning, by a scanner, the 3D oral device to generate a 3D scan file of the 3D oral device; comparing, by one or more processors, the 3D scan file with the data file to determine at least one feature represented in the 3D scan file that exceeds a deviation threshold relative to a corresponding respective feature represented in the data file; and finishing, by a finishing module, the 3D oral device by smoothing the at least one feature on the 3D oral device.

In a variation of this aspect, the 3D scan file may be a first 3D scan file, and the method may further comprise: scanning, by the scanner, the 3D oral device to generate a second 3D scan file of the 3D oral device; and comparing, by the one or more processors, the second 3D scan file with the data file to determine whether or not at least one feature represented in the second 3D scan file exceeds the deviation threshold relative to a corresponding respective feature represented in the data file.

In another variation of this aspect, the finishing module may comprise at least one of a sandblaster and a vapor smoother.

In yet another variation of this aspect, the deviation threshold may be approximately 50 microns, and the method may further comprise: identifying, by the one or more processors, a respective feature represented in the 3D scan file that deviates from a corresponding feature in the data file by at least 100 microns; and designating, by the one or more processors, the 3D oral device for manual finishing.

In still another variation of this aspect, the 3D printer may be further configured to print the 3D oral device onto (i) a flexible build platform or (ii) a conveyor belt, and the flexible build platform may include a unique identifying label encoded with oral device data corresponding to the 3D oral device. Further in this variation, the method may further comprise: storing, on a server, (i) the data file, (ii) the 3D scan file, and (iii) the oral device data.

In yet another variation of this aspect, the 3D oral device may comprise (i) a base portion, (ii) a teeth portion, and (iii) a support portion. Further in this variation, the method may further comprise: printing, by the 3D printer, the 3D oral device by utilizing a first material for the base portion, a second material for the teeth portion, and a third material for the support portion.

In still another variation of this aspect, the third material for the support portion may be dissolvable, and the method may further comprise: placing, by an autonomous robotic arm, the 3D oral device into a bath configured to dissolve the support portion; automatically removing, by the autonomous robotic arm, the 3D oral device from the bath when the support portion is dissolved; and placing, by the autonomous robotic arm, the 3D oral device into the finishing module.

In yet another variation of this aspect, the method may further comprise: responsive to the 3D printer printing the 3D oral device, automatically grabbing, by an autonomous robotic arm, the 3D oral device within the 3D printer to remove the 3D oral device from the 3D printer.

In yet another aspect, the present invention may be a non-transitory computer-readable storage medium having stored thereon a set of instructions, executable by at least one processor, for network enabled, three-dimensional (3D) printing and automated processing of oral devices. The instructions may comprise: instructions for receiving, via a network, a data file representative of a mouth of a user; instructions for converting the data file to a set of code that is executable by a 3D printer; instructions for executing the set of code to print a 3D oral device with the 3D printer; instructions for automatically ejecting the 3D oral device from the 3D printer; instructions for scanning the 3D oral device to generate a 3D scan file of the 3D oral device; instructions for comparing the 3D scan file with the data file to determine at least one feature represented in the 3D scan file that exceeds a deviation threshold relative to a corresponding respective feature represented in the data file; and instructions for finishing the 3D oral device by smoothing the at least one feature on the 3D oral device.

Advantageously, the techniques of the present disclosure relate to improvements to other technologies or technical fields at least because the present disclosure describes or introduces improvements to oral device fabrication devices and the field of oral device fabrication generally, where data files representative of user's mouths are remotely uploaded directly to an network enabled, oral device fabrication system that proceeds to autonomously print, scan, and finish an oral device specified by the uploaded data file. This improves over the prior art at least because existing systems lack such autonomous functionality and are simply not capable of converting user-specific data files into executable formats that thereby enable the system to output a fully fabricated oral device that accurately replicates the device represented by the user-specific data file.

In addition, the present disclosure relates to improvement to other technologies or technical fields at least because the present disclosure describes or introduces improvements to computing devices in the oral device fabrication field, whereby the data file conversion module and the oral device processing application executing on the central server and/or computing devices (e.g., 3D printer, scanner, finishing module) improve the underlying computer devices, as such computer devices are made more efficient by the configuration, adjustment, or adaptation of the disclosed network architecture. For example, in some aspects, fewer machine resources (e.g., processing cycles or memory storage) may be used by decreasing the computational resources required as a result of the network architecture utilized to fabricate 3D oral devices compared to conventional systems. Such reduction frees up the computational resources of an underlying computing system, thereby making it more efficient.

The present disclosure also includes applying certain of the claim elements with, or by use of, a particular machine, e.g., a 3D printer, which receives a data file representative of a mouth of a user, prints a 3D oral device based on the data file, and automatically ejects the 3D oral device. In addition, the present disclosure includes specific features other than what is well-understood, routine, conventional activity in the field, or adding unconventional steps that confine the claim to a particular useful application, e.g., converting a data file into a set of code that is executable by a 3D printer, executing the set of code to print a 3D oral device with the 3D printer; scanning the 3D oral device and comparing the 3D scan file with the data file to determine at least one feature represented in the 3D scan file that exceeds a deviation threshold relative to a corresponding respective feature represented in the data file; and finishing the 3D oral device by smoothing the at least one feature on the 3D oral device.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

FIG. 1A is an example system for 3D printing and automated processing of oral devices, in accordance with embodiments described herein.

FIG. 1B is an example network enabled, oral device fabrication system of FIG. 1A for 3D printing and automated processing of oral devices, in accordance with embodiments described herein.

FIG. 2 is an example oral device printing flowchart for network enabled 3D printing and automated processing of oral devices, in accordance with embodiments described herein.

FIG. 3 is a flowchart representative of a method for network enabled 3D printing and automated processing of oral devices, in accordance with embodiments described herein.

### DETAILED DESCRIPTION

The present embodiments relate to, inter alia, network enabled 3D printing and automated processing of oral devices (also referenced herein as “3D oral devices”). For instance, depth information of a patient's mouth (e.g., including depth information of the patient's teeth, gums, arches, one structure and so forth) may be acquired using an infrared scanner or any suitable oral scanning device. The depth information, represented within a data file, may then be transmitted over a network to a network enabled, oral device fabrication system that converts the data file into an executable format and proceeds to fabricate the oral device represented within the data file. The oral device may generally be and/or include dentures, implants, aligners, crowns, veneers, partials, relines, mouth guards, retainers, and so forth.

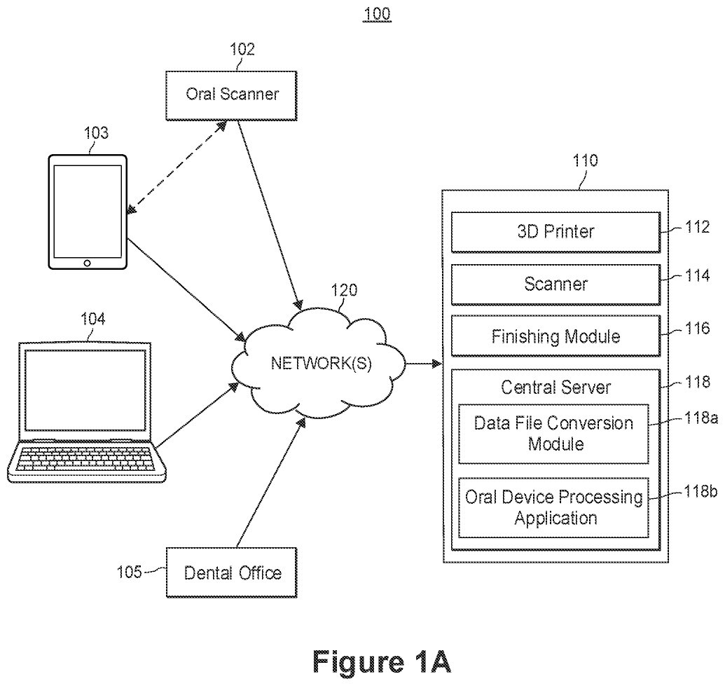

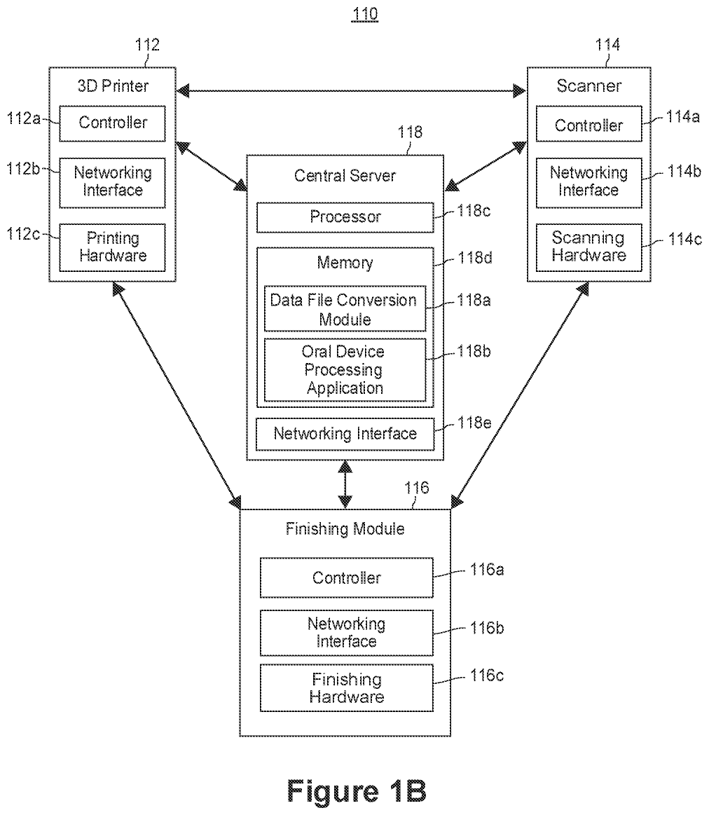

FIG. 1A is an example system 100 for 3D printing and automated processing of oral devices, in accordance with embodiments described herein. Generally, the example system 100 may facilitate the end-to-end processing of a 3D oral device from an initial scan of a patient's (also referenced herein as a “user”) mouth to the printing and finishing of a corresponding oral device. The example system 100 may include an oral scanner 102, user computing devices 103 and 104, a dental office 105, a network enabled, oral device fabrication system 110 (also referenced herein as an “oral device processing system” and “oral device system”), and a network 120.

The oral scanner 102 (or an oral scanner at the dental office 105) may generally capture images of the interior of a patient's mouth with an RGB camera or other suitable camera, and may transmit those images to a connected computing device (e.g., user computing device 103, 104, oral device system 110) for processing. The connected computing device may operate/execute an application or platform configured to receive the images captured by the oral scanner 102, and to process the captured images such that the data contained in the images is represented as part of a data file that is transmitted to/utilized by the oral device system 110. The oral scanner 102 may mobilize the platform of the connected computing device using native iOS or android apps running on the connected computing device (which includes one or more processors, e.g., one or more scanning processors). In some embodiments, the oral scanner 102 is an infrared scanner including an emitter (not shown, also sometimes referred to as a “projector”) and receiver (not shown, e.g., a sensor).

In certain aspects, the oral scanner 102 and/or the connected computing device may create a 3D model of a patient's mouth interior using raw depth feed data (e.g. from the infrared scanner and/or from a laser scanner) instead of an RGB camera. Of course, it is also possible for the oral scanner 102 and/or the connected computing device to create a 3D model of a patient's mouth interior using RGB data and a photogrammetry pipeline. Generally, the raw depth data becomes more accurate as the receiver is moved closer to objects in the mouth, including teeth or gum tissue. Thus, in some examples, a human operator will press the oral scanner 102 into contact with a patient's teeth or gums. However, holding the oral scanner 102 a few inches away from a patient's teeth will still produce accurate depth information; and, even if the oral scanner 102 is a few meters away from the target, depth information may still be obtained. The signal from the receiver can be created by a single paired infrared emitter and receiver, which typically costs less to produce than the RGB camera found on most modern smartphones. In certain aspects, the raw depth data is in the form of a point cloud (e.g., a dataset that represents object(s) in space).

In order to produce the raw depth feed data, the oral scanner 102 (e.g., via an emitter) emits dots that are reflected within the patient's mouth interior and subsequently received by the oral scanner 102 (e.g., via a receiver) and processed by the oral scanner 102 and/or a connected computing device (e.g., user computing device 103, 104, oral device system 110). This processing generally produces a raw depth feed, which is an integer, usually measured in microns, indicating the distance between the oral scanner 102 and the object being scanned (e.g., a tooth or gum). The oral scanner 102 and/or the connected computing device may then compile the raw depth feed data and/or other suitable data (e.g., image/pixel data) received by the oral scanner 102 into a data file of any suitable format, for example, the industry standard OBJ and STL formats. In certain aspects, a native application can connect the raw depth feed data and/or images created by the oral scanner 102 to an application programming interface (API) that turns the data into a 3D model as part of a computer-aided design (CAD) file format that digitally represents the 3D model of the patient's mouth interior. Additionally, in some aspects, the software executed on the oral scanner 102 and/or the connected computing device may use real-time web communication technologies (such as those used in video chatting applications) to stream data from the scanner 102 and/or the connected computing device to a server (e.g., central server 118) for rendering. In any event, once the scans are created, they can be stored for future retrieval in an S3-compatible object storage system.

In some aspects, the oral scanner 102 may emit/receive approximately 30,000 dots per second. Further, in some aspects, a human operator may operate the oral scanner 102 such that a very large percentage (e.g., 90%) of the emitted dots hit a tooth or other target objects/areas in a patient's mouth. In certain aspects, the connected computing device may provide an alarm or indication to the human operator if less than a certain percentage (e.g., 90%) of the emitted dots are not hitting the target objects/areas within the patient's mouth.

In addition, although the example of FIG. 1A shows the oral scanner 102 optionally connected to the user computing device 103 (e.g., a smartphone), it should be understood that the data from the oral scanner 102 may be received and processed by any suitable processing device. Accordingly, in the example of FIG. 1A, the data obtained by the oral scanner 102 may be processed by the user computing devices 103, 104, at the dental office 105, and/or at the oral device system 110.

The oral device system 110 is generally configured to receive data files from a user computing device (e.g., any of devices/locations 102-105) that are representative of a patient's mouth, and to autonomously fabricate an oral device to fit within the patient's mouth. The oral device system 110 includes a 3D printer 112, a scanner 114, a finishing module 116, and a central server 118. The central server 118 may include a data file conversion module 118a that is configured to receive the data file across the network 120 and to convert the data file into executable code that may allow, for example, the 3D printer 112 to print an oral device based on the data file. The central server 119 may also include an oral device processing application 118b that is generally configured to manage the processing of the oral device throughout the various stages of fabrication, e.g., printing, scanning, and finishing. The oral device processing application 118b may communicate with each of the 3D printer 112, the scanner 114, and the finishing module 116 in order to transmit processing instructions related to the oral device that are included as part of the executable code generated by the data file conversion module 118a.

Generally, each of the components of the oral device system 110 may include various sub-components configured to enable the components to perform the various functions described herein. For example, in reference to FIG. 1B, each of the 3D printer 112, the scanner 114, and the finishing module 116 may include a controller (112a, 114a, 116a) and a networking interface (112b, 114b, 116b). Of course, it is to be appreciated that the controllers (112a, 114a, 116a) of each of the 3D printer 112, the scanner 114, and the finishing module 116 may be a microcontroller that includes one or more processors (e.g., central processing unit (CPU)), an input/output interface, and/or one or more memories. Moreover, in certain aspects, each of the 3D printer 112, the scanner 114, and/or the finishing module 116 may store all or a portion of the oral device processing application 118b locally, such that each device (112, 114, 116) may independently perform tasks as part of the oral device fabrication without communication with a central server (e.g., central server 118). It should also be appreciated that any mention of a processor, a memory, and/or a controller may reference one or more processors, one or more memories, and one or more controllers.

In any event, the 3D printer 112 may include a controller 112a, a networking interface 112b, and printing hardware 112c. Broadly, the 3D printer 112 may receive executable code from the central server 118 and/or a patient device (e.g., oral scanner 102, user computing device 103, 104, and/or dental office 105) via a wireless connection (e.g., via network 120) and/or a hardwired connection through the networking interface 112b. The controller 112a may then interpret the executable code and automatically cause the printing hardware 112c to proceed with printing an oral device in accordance with the specifications provided within the executable code.

When the 3D printer 112 has finished printing the oral device specified within the executable code, the central server 118 (via the oral device processing application 118b) may instruct the scanner 114 to scan the oral device in order to determine whether or not any defects/deviations exist relative to the 3D model embodied in the data file. Generally, the scanner 114 may include a controller 114a, a networking interface 114b, and scanning hardware 114c. The scanner 114 may receive executable code from the central server 118 and/or a patient device (e.g., oral scanner 102, user computing device 103, 104, and/or dental office 105) via a wireless connection (e.g., via network 120) and/or a hardwired connection through the networking interface 114b. The controller 114a may then interpret the executable code and automatically cause the scanning hardware 114c to proceed with scanning the oral device. As a result, the scanner 114 may generate a 3D scan file of the oral device that includes the dimensions of the oral device. The scanner 114 (e.g., via the controller 114a) may further compare the 3D scan file of the oral device to the original data file in order to determine whether or not a dimension of a portion of the oral device (also referenced herein as a “feature”) exceeds a deviation threshold relative to the corresponding dimension of the portion of the oral device specified within the data file.

In the event that a feature of the printed oral device exceeds the deviation threshold, the central server 118 (via the oral device processing application 118b) may instruct the finishing module 116 to finish the identified feature of the oral device such that the feature is within the deviation threshold after finishing. Generally, the finishing module 116 may include a controller 116a, a networking interface 116b, and finishing hardware 116c. As described herein, the finishing hardware 116c may be any suitable finishing hardware, such as a vapor smoother, sandblaster, and/or other hardware or combinations thereof. The finishing module 116 may receive executable code from the central server 118 and/or a patient device (e.g., oral scanner 102, user computing device 103, 104, and/or dental office 105) via a wireless connection (e.g., via network 120) and/or a hardwired connection through the networking interface 116b. The controller 116a may then interpret the executable code and automatically cause the finishing hardware 116c to proceed with finishing the oral device, such that at least the identified feature(s) of the oral device are brought within the deviation threshold relative to the corresponding dimension of the portion of the oral device specified within the data file.

In certain aspects, the central server 118 may instruct the scanner 114 (e.g., via the controller 114a) to scan the finished oral device to generate a 3D scan file of the finished oral device, and thereafter compare the 3D scan file of the finished oral device to the original data file in order to determine whether or not a dimension of a feature of the finished oral device exceeds the deviation threshold relative to the corresponding dimension of the feature of the oral device specified within the data file. In these aspects, responsive to the scanner 114 determining that a feature of the finished oral device exceeds the deviation threshold relative to the corresponding dimension of the feature of the oral device specified within the data file, the central server 118 may instruct the finishing module 116 to finish the oral device a subsequent time to further finish at least the feature, such that the feature does not exceed the deviation threshold. Accordingly, the central server 118 may instruct the scanner 114 and the finishing module 116 to automatically re-scan and re-finish the oral device any number of times in order to ensure that all features of the oral device do not exceed the deviation threshold relative to the corresponding dimension of the feature of the oral device specified within the data file.

As illustrated in FIG. 1B, the central server 118 may include a processor 118c, a memory 118d containing the data file conversion module 118a and the oral device processing application 118b, and a networking interface 118e. The memory 118d (as well as the memories included as part of the controllers 112a, 114a, 116a) may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memory 118d (as well as the memories included as part of the controllers 112a, 114a, 116a) may store an operating system (OS) (e.g., Microsoft Windows, Linux, UNIX, etc.) capable of facilitating the functionalities, apps, methods, or other software as discussed herein. In addition, the memory 118d (as well as the memories included as part of the controllers 112a, 114a, 116a) may also store machine readable instructions, including any of one or more application(s) (e.g., oral device processing application 118b), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. For example, at least some of the applications, software components, or APIs may be, include, otherwise be part of, the oral device processing application 118b, where each may be configured to facilitate their various functionalities discussed herein. It should be appreciated that one or more other applications may be envisioned and that are executed by the processor 118c and/or the controllers 112a, 114a, 116a.

The processor 118c may be connected to the memory 118d via a computer bus responsible for transmitting electronic data, data packets, or otherwise electronic signals to and from the processor 118c and the memory 118d in order to implement or perform the machine readable instructions, methods, processes, elements or limitations, as illustrated, depicted, or described for the various flowcharts, illustrations, diagrams, figures, and/or other disclosure herein. The processor 118c may interface with memory 118d via the computer bus to execute an operating system (OS). The processor 118c may also interface with the memory 118d via the computer bus to create, read, update, delete, or otherwise access or interact with the data stored in the memory 118d and/or an external database (not shown) (e.g., a relational database, such as Oracle, DB2, MySQL, or a NoSQL based database, such as MongoDB).

The networking interface 118e (as well as the interfaces 112b, 114b, 116b) may be configured to communicate (e.g., send and receive) data via one or more external/network port(s) to one or more networks or local terminals, such as computer network 120. In some aspects, the central server 118 may include a client-server platform technology such as ASP.NET, Java J2EE, Ruby on Rails, Node.js, a web service or online API, responsive for receiving and responding to electronic requests. The central server 118 may implement the client-server platform technology that may interact, via the computer bus, with the memory 118d (including the applications(s), component(s), API(s), data, etc. stored therein) to implement or perform the machine readable instructions, methods, processes, elements or limitations, as illustrated, depicted, or described for the various flowcharts, illustrations, diagrams, figures, and/or other disclosure herein.

In various aspects, the central server 118 may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to the computer network 120. In some embodiments, the computer network 120 may comprise a private network or local area network (LAN). Additionally, or alternatively, the computer network 120 may comprise a public network such as the Internet.

The central server 118 may further include or implement an operator interface configured to present information to an administrator or operator and/or receive inputs from the administrator or operator. For example, an operator interface may provide a display screen on a computing device located at an oral device fabrication facility containing the oral device system 110, and/or the central server 118 may generate the operator interface on a patient's computing device (e.g., user computing devices 103, 104). The central server 118 may also provide I/O components (e.g., ports, capacitive or resistive touch sensitive input panels, keys, buttons, lights, LEDs), which may be directly accessible via, or attached to, the central server 118 or may be indirectly accessible via or attached to a terminal. According to some aspects, an administrator/operator (e.g., a dentist or dental technician), and/or a patient may access the central server 118 to review information, make changes, input data files, initiate oral device processing, and/or perform other functions.

As described herein, in some aspects, the central server 118 may perform the functionalities as discussed herein as part of a “cloud” network or may otherwise communicate with other hardware or software components within the cloud to send, retrieve, or otherwise analyze data or information described herein.

In general, a computer program or computer based product, application (e.g., oral device processing application 118b), or code may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor 118c and/or the controllers 112a, 114a, 116a (e.g., working in connection with the respective operating system in memory 118d) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.).

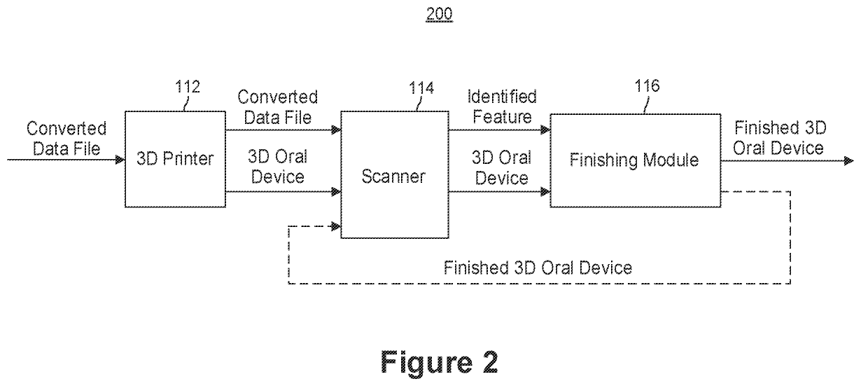

FIG. 2 is an example oral device printing flowchart 200 for network enabled 3D printing and automated processing of oral devices, in accordance with embodiments described herein. Generally, the example oral device printing flowchart 200 depicts the end-to-end fabrication of an oral device after a patient submits a data file containing data representative of the interior of the patient's mouth. The data file may also include instructions related to a type or quantity of oral device the patient desires/requires. For example, the patient may submit a data file containing the data representative of the interior of the patient's mouth and may additionally indicate that the patient requires two sets of partial dentures for one or more teeth that are missing from the patient's mouth. Additionally, in some aspects, the patient may submit a data file requesting more than one type of oral device (e.g., dentures, partials, mouth guards, implants, aligners, crowns, veneers, relines, retainers, etc.).

In any event, when the patient submits a data file, the central server (e.g., central server 118) and/or the 3D printer 112 may receive the data file, and proceed to convert the data file into executable code. Thereafter, the 3D printer 112 may receive the converted data file and execute the code contained therein to produce a 3D oral device. The 3D printer 112 may then transmit the 3D oral device and some/all of the converted data file to the scanner 114. Of course, the 3D printer 112 may additionally, or alternatively, transmit an indication of a successful print to the central server, and the server may then transmit some/all of the converted data file to the scanner 114.

The scanner 114 may receive the 3D oral device and the converted data file, and proceed to scan the 3D oral device to generate a 3D scan file of the 3D oral device. The 3D scan file of the 3D oral device may include and/or otherwise represent the dimensionality of the 3D oral device, as received from the 3D printer 112. For example, the 3D scan file may include a graphical (e.g., pictorial) rendering of the 3D oral device, and may include dimensional data (e.g., lengths, widths, depths, etc.) corresponding to the 3D oral device. In certain aspects, the scanner 114 may transmit a graphical rendering of the 3D oral device to a patient's device (e.g., user computing devices 103, 104, dental office 105) for the patient to view the oral device.

When the scanner 114 generates the 3D scan file, the scanner 114 may automatically compare the 3D scan file with the converted data file to determine whether or not any feature of the 3D oral device within the 3D scan file exceeds a deviation threshold. For example, assume that the 3D oral device is a partial that is intended to replace a single tooth in a patient's mouth. In this example, the scanner 114 may evaluate the 3D scan file of the 3D oral device to determine the width, length, depth, height, etc. associated with the tooth in various directions. To illustrate, the length across the top of the tooth may differ depending on which two opposite points of the tooth are being used to determine the length. Similarly, each feature of the tooth may be described by any number of dimensions. The scanner 114 may then compare these dimensions for each feature of the tooth within the 3D scan file to the corresponding dimensions of the tooth included as part of the converted data file. If the scanner 114 determines that the any of the dimensions for any of the features of the 3D scan file exceed the deviation threshold relative to the corresponding dimensions of the feature included within the converted data file, the scanner 114 may generate an identified feature to be sent to the finishing module 116 so that the module 116 may finish the oral device and thereby bring the dimensions of the identified feature within the deviation threshold. In certain aspects, the deviation threshold may be approximately 50 microns.

However, in certain aspects, the scanner 114 may determine that a particular feature included in the 3D scan file should be finished by the finishing module 116 despite not exceeding the deviation threshold. For example, the scanner 114 may scan the oral device and determine that the 3D scan file includes a feature that deviates from the corresponding feature in the converted data file by an equivalent or approximately equivalent (e.g., within 1-2 microns) amount as the deviation threshold. In this example, the scanner 114 may determine that the feature should be finished by the finishing module 116, despite not exceeding the deviation threshold.

When the scanner 114 has completed scanning the 3D oral device and generating any identified features, the scanner 114 may transmit the 3D oral device and the identified features to the finishing module 116 to finish the 3D oral device. Generally, and as previously mentioned, the finishing module 116 may include a vapor smoother configured to finish the 3D oral device through the management of temperature, pressure, and concentration of solvent vapors. Of course, the finishing module 116 may additionally or alternatively include other finishing hardware, such as a sandblaster or the like.

In any event, the finishing module 116 receives the 3D oral device and the identified features from the scanner 114 and proceeds to automatically finish the 3D oral device such that the 3D oral device more closely resembles the model included as part of the patient's data file (e.g., included within the converted data file). When the finishing module 116 finishes the 3D oral device, the finishing module 116 outputs a finished 3D oral device, wherein the dimensions of all features of the finished 3D oral device do not exceed the deviation threshold relative to the corresponding dimensions of the features included within the converted data file.

Optionally, the finishing module 116 may send the finished 3D oral device to the scanner 114 to scan the finished 3D oral device and determine whether or not any features of the finished 3D oral device exceed the deviation threshold relative to the corresponding dimensions of the features included within the converted data file. Should the scanner 114 determine that a dimension of a feature of the finished 3D oral device still exceeds the deviation threshold relative to the corresponding dimension of the feature included within the converted data file, the scanner 114 may identify the feature, and transmit the finished 3D oral device and the identified feature to the finishing module 116 to be re-finished. This finishing, re-scanning, and re-finishing cycle may continue any suitable number of times to ensure that all dimensions of the finished 3D oral device do not exceed the deviation threshold relative to the corresponding dimensions of the model represented within the converted data file.

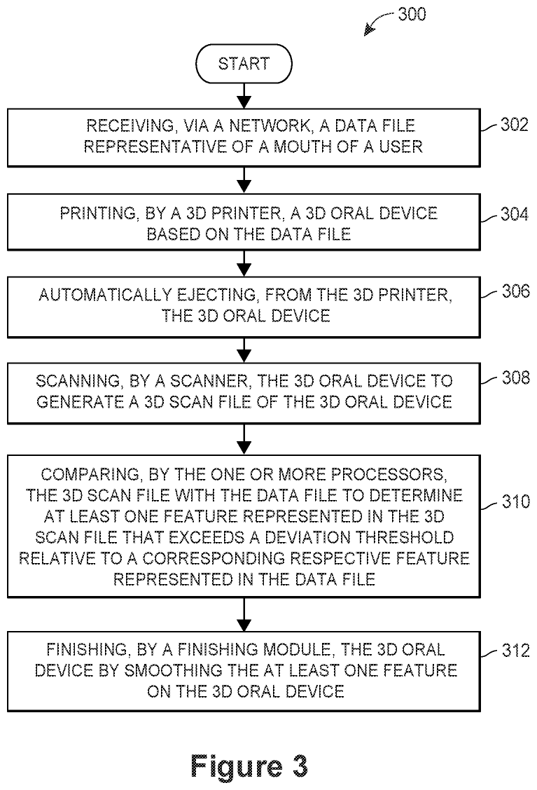

FIG. 3 is a flowchart representative of a method 300 for network enabled 3D printing and automated processing of oral devices, in accordance with embodiments described herein. The method 300 may include receiving, via a network, a data file representative of a mouth of a user (block 302). In certain aspects, the data file conversion module may convert the data file into a set of code that is executable by the 3D printer to print the 3D oral device.

The method 300 may also include printing a 3D oral device based on the data file (block 304). A 3D printer (e.g., 3D printer 112) may print the 3D oral device, and the 3D printer may receive a converted data file from which the 3D printer may obtain the dimensions and materials corresponding to each component of the 3D oral device. In certain aspects, the 3D printer is further configured to print the 3D oral device onto (i) a flexible build platform or (ii) a conveyor belt. In these aspects, the flexible build platform may include a unique identifying label encoded with oral device data corresponding to the 3D oral device. For example, the unique identifying label may include any suitable indicia (e.g., barcode, quick response (QR) code, radio frequency identification (RFID) tag, etc.), and the indicia may be encoded with a payload that includes and/or corresponds to the oral device data. Moreover, in these aspects, a server (e.g., central server 118) may be communicatively coupled with the 3D printer, the one or more processors, the scanner, and the finishing module, and may store each of the data file, the 3D scan file, and the oral device data.

In some aspects, the 3D oral device comprises (i) a base portion, (ii) a teeth portion, and (iii) a support portion. In these aspects, the 3D printer may be further configured to print the 3D oral device by utilizing a first material for the base portion, a second material for the teeth portion, and a third material for the support portion. Each of the first material, the second material, and the third material may be identical materials, different materials, and/or any suitable combinations thereof. For example, the first material and the second material may be identical, while the third material is different from the first and second materials. As another example, the first material may be different from each of the second and third materials, and the second material may be different from the third material. Further in these aspects, the third material for the support portion may be dissolvable, such that when the 3D oral device is placed in a dissolving bath, the support portion may dissolve away and the remainder of the 3D oral device (e.g., denture, partial, etc.) may be removed.

As an example, in the prior aspects, the base portion and the teeth portion may both be printed utilizing polyamide (e.g., nylon). More specifically, in this example, both the first material and the second material may be polyamide that is utilized by the 3D printer to print the base portion and the teeth portion of the 3D oral device. The first material may be polyamide of a first color, and the second material may be polyamide of a second color. For instance, the polyamide comprising the first material may be a pink color that is similar to the color of a patient's gums, and the polyamide comprising the second material may be a white/off-white color that is similar to the color of the patient's teeth.

In the above example, 3D printing both the base portion and the teeth portion from polyamide results in several advantages. Namely, utilizing a single material (polyamide) to additively manufacture the 3D oral device enables the 3D printer to quickly and efficiently print the entire 3D oral device (along with the support portion) without any additional equipment. Conventional techniques at least require additionally creating of an injection mold in order to fabricate such a homogenous oral device, which typically includes an additional degree of manual intervention/adjustment to complete the oral device fabrication. In this manner, the techniques of the present disclosure may alleviate many issues related to conventional oral prosthetic manufacture, such as expensive and time-intensive injection mold fabrication, inaccurate and laborious hand modeling/finishing of plaster prostheses, and overall scalability limitations resulting from these and other issues, among others.

Additionally, in certain aspects, the system may further comprise an autonomous robotic arm communicatively coupled with the one or more processors. The autonomous robotic arm may be configured to place the 3D oral device into a bath configured to dissolve the support portion, automatically remove the 3D oral device from the bath when the support portion is dissolved, and place the 3D oral device into the finishing module. Moreover, in some aspects, the autonomous robotic arm may, responsive to the 3D printer printing the 3D oral device, automatically grab the 3D oral device within the 3D printer to remove the 3D oral device from the 3D printer.

The method 300 may also include automatically ejecting, from the 3D printer, the 3D oral device (block 306). Once ejected, the scanner (e.g., scanner 114) may scan the 3D oral device to generate a 3D scan file of the 3D oral device (block 308). The scanner and/or any other suitable processor (e.g., processor 118c) may proceed to compare the 3D scan file with the data file to determine at least one feature represented in the 3D scan file that exceeds a deviation threshold relative to a corresponding respective feature represented in the data file (block 310).

In certain aspects, the deviation threshold may be approximately 50 microns. Of course, it should be understood that the deviation threshold may be any suitable dimension, and may represent a threshold that deviations are not to exceed, a plurality of thresholds indicating a relative degree of deviation from the data file, and/or any other suitable threshold or combinations thereof. For example, the deviation threshold may represent three distinct categories of deviations (e.g., mild, intermediate, severe) that may result in the scanner and/or other suitable processor instructing the finishing module to conduct a corresponding amount of finishing (e.g., low, medium, high) to the 3D oral device.

In some aspects, the scanner may also identify a respective feature represented in the 3D scan file that deviates from a corresponding respective feature in the data file by at least 100 microns. In this case, the scanner (or other suitable processor) may designate the 3D oral device for manual finishing. For example, the 3D printer may print a particular feature of the 3D oral device such that the dimensions of the feature exceed the deviation threshold by over 100 microns, and as a result, a human operator may be able to quickly (e.g., quicker than the finishing module) apply a rough finish to the 3D oral device to bring the feature closer to the deviation threshold. Thereafter, the scanner may re-scan the 3D oral device, and likely send the 3D oral device to the finishing module for a finer grain finish to ensure that the identified feature does not exceed the deviation threshold.

The method 300 may also include finishing, by a finishing module (e.g., finishing module 116), the 3D oral device by smoothing the at least one feature on the 3D oral device (block 312). In some aspects, and as previously mentioned, the finishing module may include at least one of a vapor smoother and/or a sandblaster.

However, in certain circumstances, the finishing module may not sufficiently finish the entire 3D oral device, such that all dimensions of the features of the 3D oral device do not exceed the deviation threshold. Thus, in certain aspects, the 3D scan file may be a first 3D scan file, and the scanner may be further configured to receive the 3D oral device from the finishing module; scan the 3D oral device to generate a second 3D scan file of the 3D oral device; and compare the second 3D scan file with the data file to determine whether or not at least one feature represented in the second 3D scan file exceeds the deviation threshold relative to a corresponding respective feature represented in the data file.

### Additional Aspects

1. A network enabled, three-dimensional (3D) printing and automated processing system for oral devices, the system comprising: a 3D printer coupled with one or more processors, the 3D printer configured to: receive, via a network, a data file representative of a mouth of a user, print a 3D oral device based on the data file, and automatically eject the 3D oral device; a scanner communicatively coupled with the 3D printer and the one or more processors, the scanner configured to: receive the 3D oral device from the 3D printer, scan the 3D oral device to generate a 3D scan file of the 3D oral device, and compare the 3D scan file with the data file to determine at least one feature represented in the 3D scan file that exceeds a deviation threshold relative to a corresponding respective feature represented in the data file; and a finishing module communicatively coupled with the one or more processors and the scanner, the finishing module configured to: receive the 3D oral device from the scanner, and finish the 3D oral device by smoothing the at least one feature on the 3D oral device.

2. The network enabled, 3D printing and automated processing system of aspect 1, wherein the 3D scan file is a first 3D scan file, and the scanner is further configured to: receive the 3D oral device from the finishing module, scan the 3D oral device to generate a second 3D scan file of the 3D oral device, and compare the second 3D scan file with the data file to determine whether or not at least one feature represented in the second 3D scan file exceeds the deviation threshold relative to a corresponding respective feature represented in the data file.

3. The network enabled, 3D printing and automated processing system of any of aspects 1-2, wherein the finishing module comprises at least one of a sandblaster and a vapor smoother.

4. The network enabled, 3D printing and automated processing system of any of aspects 1-3, wherein the deviation threshold is approximately 50 microns.

5. The network enabled, 3D printing and automated processing system of any of aspects 1-4, wherein the one or more processors are configured to: identify a respective feature represented in the 3D scan file that deviates from a corresponding respective feature in the data file by at least 100 microns, and designate the 3D oral device for manual finishing.

6. The network enabled, 3D printing an automated processing system of any of aspects 1-5, wherein the one or more processors are configured to: convert the data file into a set of code that is executable by the 3D printer to print the 3D oral device.

7. The network enabled, 3D printing and automated processing system of any of aspects 1-6, wherein the 3D printer is further configured to print the 3D oral device onto (i) a flexible build platform or (ii) a conveyor belt.

8. The network enabled, 3D printing and automated processing system of aspect 7, wherein the flexible build platform includes a unique identifying label encoded with oral device data corresponding to the 3D oral device, and the system further comprises a server communicatively coupled with the 3D printer, the one or more processors, the scanner, and the finishing module, wherein the server is configured to: store the data file, the 3D scan file, and the oral device data.

9. The network enabled, 3D printing and automated processing system of any of aspects 1-8, wherein the 3D oral device comprises (i) a base portion, (ii) a teeth portion, and (iii) a support portion, and wherein the 3D printer is further configured to: print the 3D oral device by utilizing a first material for the base portion, a second material for the teeth portion, and a third material for the support portion.

10. The network enabled, 3D printing and automated processing system of aspect 9, wherein the third material for the support portion is dissolvable, and the system further comprises an autonomous robotic arm communicatively coupled with the one or more processors that is configured to: place the 3D oral device into a bath configured to dissolve the support portion, automatically remove the 3D oral device from the bath when the support portion is dissolved, and place the 3D oral device into the finishing module.

11. The network enabled, 3D printing and automated processing system of any of aspects 1-10, further comprising an autonomous robotic arm communicatively coupled with the one or more processors that is configured to: responsive to the 3D printer printing the 3D oral device, automatically grab the 3D oral device within the 3D printer to remove the 3D oral device from the 3D printer.

12. A method for network enabled, three-dimensional (3D) printing and automated processing of oral devices, the method comprising: receiving, via a network, a data file representative of a mouth of a user; printing, by a 3D printer, a 3D oral device based on the data file; automatically ejecting, from the 3D printer, the 3D oral device; scanning, by a scanner, the 3D oral device to generate a 3D scan file of the 3D oral device; comparing, by one or more processors, the 3D scan file with the data file to determine at least one feature represented in the 3D scan file that exceeds a deviation threshold relative to a corresponding respective feature represented in the data file; and finishing, by a finishing module, the 3D oral device by smoothing the at least one feature on the 3D oral device.

13. The method of aspect 12, wherein the 3D scan file is a first 3D scan file, and the method further comprises: scanning, by the scanner, the 3D oral device to generate a second 3D scan file of the 3D oral device; and comparing, by the one or more processors, the second 3D scan file with the data file to determine whether or not at least one feature represented in the second 3D scan file exceeds the deviation threshold relative to a corresponding respective feature represented in the data file.

14. The method of any of aspects 12-13, wherein the finishing module comprises at least one of a sandblaster and a vapor smoother.

15. The method of any of aspects 12-14, wherein the deviation threshold is approximately 50 microns, and the method further comprises: identifying, by the one or more processors, a respective feature represented in the 3D scan file that deviates from a corresponding feature in the data file by at least 100 microns; and designating, by the one or more processors, the 3D oral device for manual finishing.

16. The method of any of aspects 12-15, wherein the 3D printer is further configured to print the 3D oral device onto (i) a flexible build platform or (ii) a conveyor belt, the flexible build platform includes a unique identifying label encoded with oral device data corresponding to the 3D oral device, and the method further comprises: storing, on a server, (i) the data file, (ii) the 3D scan file, and (iii) the oral device data.

17. The method of any of aspects 12-16, wherein the 3D oral device comprises (i) a base portion, (ii) a teeth portion, and (iii) a support portion, and wherein the method further comprises: printing, by the 3D printer, the 3D oral device by utilizing a first material for the base portion, a second material for the teeth portion, and a third material for the support portion.

18. The method of aspect 17, wherein the third material for the support portion is dissolvable, and the method further comprises: placing, by an autonomous robotic arm, the 3D oral device into a bath configured to dissolve the support portion; automatically removing, by the autonomous robotic arm, the 3D oral device from the bath when the support portion is dissolved; and placing, by the autonomous robotic arm, the 3D oral device into the finishing module.

19. The method of any of aspects 12-18, further comprising: responsive to the 3D printer printing the 3D oral device, automatically grabbing, by an autonomous robotic arm, the 3D oral device within the 3D printer to remove the 3D oral device from the 3D printer.

20. A non-transitory computer-readable storage medium having stored thereon a set of instructions, executable by at least one processor, for network enabled, three-dimensional (3D) printing and automated processing of oral devices, the instructions comprising: instructions for receiving, via a network, a data file representative of a mouth of a user; instructions for converting the data file to a set of code that is executable by a 3D printer; instructions for executing the set of code to print a 3D oral device with the 3D printer; instructions for automatically ejecting the 3D oral device from the 3D printer; instructions for scanning the 3D oral device to generate a 3D scan file of the 3D oral device; instructions for comparing the 3D scan file with the data file to determine at least one feature represented in the 3D scan file that exceeds a deviation threshold relative to a corresponding respective feature represented in the data file; and instructions for finishing the 3D oral device by smoothing the at least one feature on the 3D oral device.

### Additional Considerations

The above description refers to a block diagram of the accompanying drawings. Alternative implementations of the example represented by the block diagram includes one or more additional or alternative elements, processes and/or devices. Additionally, or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

What is claimed:

1. A network enabled, three-dimensional (3D) printing and automated processing system for oral devices, the system comprising:
a 3D printer coupled with one or more processors, the 3D printer configured to:
receive, via a network, a data file representative of a mouth of a user,
print a 3D oral device based on the data file, and
automatically eject the 3D oral device;
a scanner communicatively coupled with the 3D printer and the one or more processors, the scanner configured to:
receive the 3D oral device from the 3D printer,
scan the 3D oral device to generate a 3D scan file of the 3D oral device, and
compare the 3D scan file with the data file to determine at least one feature represented in the 3D scan file that exceeds a deviation threshold relative to a corresponding respective feature represented in the data file; and
a finishing module communicatively coupled with the one or more processors and the scanner, the finishing module configured to:
receive the 3D oral device from the scanner, and
finish the 3D oral device by smoothing the at least one feature on the 3D oral device.

2. The network enabled, 3D printing and automated processing system of claim 1, wherein the 3D scan file is a first 3D scan file, and the scanner is further configured to:
receive the 3D oral device from the finishing module,
scan the 3D oral device to generate a second 3D scan file of the 3D oral device, and
compare the second 3D scan file with the data file to determine whether or not at least one feature represented in the second 3D scan file exceeds the deviation threshold relative to a corresponding respective feature represented in the data file.

3. The network enabled, 3D printing and automated processing system of claim 1, wherein the finishing module comprises at least one of a sandblaster and a vapor smoother.

4. The network enabled, 3D printing and automated processing system of claim 1, wherein the deviation threshold is approximately 50 microns.

5. The network enabled, 3D printing and automated processing system of claim 1, wherein the one or more processors are configured to:
identify a respective feature represented in the 3D scan file that deviates from a corresponding respective feature in the data file by at least 100 microns, and
designate the 3D oral device for manual finishing.

6. The network enabled, 3D printing an automated processing system of claim 1, wherein the one or more processors are configured to:
convert the data file into a set of code that is executable by the 3D printer to print the 3D oral device.

7. The network enabled, 3D printing and automated processing system of claim 1, wherein the 3D printer is further configured to print the 3D oral device onto (i) a flexible build platform or (ii) a conveyor belt.

8. The network enabled, 3D printing and automated processing system of claim 7, wherein the flexible build platform includes a unique identifying label encoded with oral device data corresponding to the 3D oral device, and the system further comprises a server communicatively coupled with the 3D printer, the one or more processors, the scanner, and the finishing module, wherein the server is configured to:
store the data file, the 3D scan file, and the oral device data.

9. The network enabled, 3D printing and automated processing system of claim 1, wherein the 3D oral device comprises (i) a base portion, (ii) a teeth portion, and (iii) a support portion, and wherein the 3D printer is further configured to:
print the 3D oral device by utilizing a first material for the base portion, a second material for the teeth portion, and a third material for the support portion.

10. The network enabled, 3D printing and automated processing system of claim 9, wherein the third material for the support portion is dissolvable, and the system further comprises an autonomous robotic arm communicatively coupled with the one or more processors that is configured to:
place the 3D oral device into a bath configured to dissolve the support portion,
automatically remove the 3D oral device from the bath when the support portion is dissolved, and
place the 3D oral device into the finishing module.

11. The network enabled, 3D printing and automated processing system of claim 1, further comprising an autonomous robotic arm communicatively coupled with the one or more processors that is configured to:
responsive to the 3D printer printing the 3D oral device, automatically grab the 3D oral device within the 3D printer to remove the 3D oral device from the 3D printer.

12. A method for network enabled, three-dimensional (3D) printing and automated processing of oral devices, the method comprising:
receiving, via a network, a data file representative of a mouth of a user;
printing, by a 3D printer, a 3D oral device based on the data file;
automatically ejecting, from the 3D printer, the 3D oral device;
scanning, by a scanner, the 3D oral device to generate a 3D scan file of the 3D oral device;
comparing, by one or more processors, the 3D scan file with the data file to determine at least one feature represented in the 3D scan file that exceeds a deviation threshold relative to a corresponding respective feature represented in the data file; and
finishing, by a finishing module, the 3D oral device by smoothing the at least one feature on the 3D oral device.

13. The method of claim 12, wherein the 3D scan file is a first 3D scan file, and the method further comprises:
scanning, by the scanner, the 3D oral device to generate a second 3D scan file of the 3D oral device; and
comparing, by the one or more processors, the second 3D scan file with the data file to determine whether or not at least one feature represented in the second 3D scan file exceeds the deviation threshold relative to a corresponding respective feature represented in the data file.

14. The method of claim 12, wherein the finishing module comprises at least one of a sandblaster and a vapor smoother.

15. The method of claim 12, wherein the deviation threshold is approximately 50 microns, and the method further comprises:
identifying, by the one or more processors, a respective feature represented in the 3D scan file that deviates from a corresponding feature in the data file by at least 100 microns; and
designating, by the one or more processors, the 3D oral device for manual finishing.

16. The method of claim 12, wherein the 3D printer is further configured to print the 3D oral device onto (i) a flexible build platform or (ii) a conveyor belt, the flexible build platform includes a unique identifying label encoded with oral device data corresponding to the 3D oral device, and the method further comprises:
storing, on a server, (i) the data file, (ii) the 3D scan file, and (iii) the oral device data.

17. The method of claim 12, wherein the 3D oral device comprises (i) a base portion, (ii) a teeth portion, and (iii) a support portion, and wherein the method further comprises:
printing, by the 3D printer, the 3D oral device by utilizing a first material for the base portion, a second material for the teeth portion, and a third material for the support portion.

18. The method of claim 17, wherein the third material for the support portion is dissolvable, and the method further comprises:
placing, by an autonomous robotic arm, the 3D oral device into a bath configured to dissolve the support portion;
automatically removing, by the autonomous robotic arm, the 3D oral device from the bath when the support portion is dissolved; and
placing, by the autonomous robotic arm, the 3D oral device into the finishing module.

19. The method of claim 12, further comprising:
responsive to the 3D printer printing the 3D oral device, automatically grabbing, by an autonomous robotic arm, the 3D oral device within the 3D printer to remove the 3D oral device from the 3D printer.

20. A non-transitory computer-readable storage medium having stored thereon a set of instructions, executable by at least one processor, for network enabled, three-dimensional (3D) printing and automated processing of oral devices, the instructions comprising:
instructions for receiving, via a network, a data file representative of a mouth of a user;
instructions for converting the data file to a set of code that is executable by a 3D printer;
instructions for executing the set of code to print a 3D oral device with the 3D printer;
instructions for automatically ejecting the 3D oral device from the 3D printer;
instructions for scanning the 3D oral device to generate a 3D scan file of the 3D oral device;
instructions for comparing the 3D scan file with the data file to determine at least one feature represented in the 3D scan file that exceeds a deviation threshold relative to a corresponding respective feature represented in the data file; and
instructions for finishing the 3D oral device by smoothing the at least one feature on the 3D oral device.
